(19) United States
(12) Patent Application Publication
(10) Pub. No.: US 2025/0051051 A1
(43) Pub. Date: Feb. 13, 2025

(54) Vented Carton

(71) Applicant: Inno-Pak, LLC, Delaware, OH (US)

(72) Inventor: Steven A. Mayer, Indianapolis, IN (US)

(73) Assignee: Inno-Pak, LLC, Delaware, OH (US)

(21) Appl. No.: 18/794,154

(22) Filed: Aug. 5, 2024

Related U.S. Application Data
(60) Provisional application No. 63/532,218, filed on Aug. 11, 2023.

(51) Int. Cl. B65D 5/42; B31B 50/26; B31B 100/00; B31B 110/35; B65D 5/02; B65D 5/46; B65D 5/48

(52) U.S. Cl. CPC B65D 5/4295; B31B 50/262; B65D 5/0254; B65D 5/46096; B65D 5/48016; B31B 2100/00; B31B 2110/35; B31B 2241/00

(57) ABSTRACT

A vented carton. The vented carton may include a container portion; a closure portion, wherein the closure portion may be configured to secure a top opening of the container portion; and an arrangement of vent openings, wherein the arrangement of vent opening may be formed in either or both of the container portion and the closure portion.

### RELATED APPLICATIONS

This application is related and claims priority to U.S. Provisional Patent Application No. 63/532,218, filed on Aug. 11, 2023 the application of which is incorporate herein by reference in its entirety.

### TECHNICAL FIELD

The presently disclosed subject matter relates generally to cartons and more particularly to vented cartons including multiple compartments, such as for food, and methods.

### BACKGROUND

Various products are known to be purchased by consumers which require a container for ease of transport. For example, in the food and grocery industry it is common to place food items in individual carry-out/to-go food containers. There may be certain drawbacks to commonly used carry-out food containers. For example, often the carry-out food container provides one compartment only for holding food. Consequently, when multiple food items are placed in the food container, the one compartment offers no means for keeping the multiple food items separate. A further drawback of carry-out food containers is that they may lack ventilation. For example, when holding hot food excessive moisture may build up inside the container, which may cause the food inside to get soggy.

### SUMMARY

In one embodiment, a vented carton is provided. The vented carton may include a container portion; a closure portion, wherein the closure portion may be configured to secure a top opening of the container portion; and an arrangement of vent openings, wherein the arrangement of vent opening may be formed in either or both of the container portion and the closure portion. The container portion may include a floor portion; a first side panel; a second side panel opposite that of the first side panel; a first end panel; and a second end panel opposite that of the first end panel, wherein the floor portion, side panels, and end panels may be configurable to form a compartment region of the container portion. The floor portion may include a first floor panel; a second floor panel; a third floor panel; and a fourth floor panel, wherein the first, second, third, and fourth floor panels may be configurable to form the floor portion of the container portion. The first floor panel may include one or more locking tabs extending from a side edge of the first floor panel, and wherein in an assembled configuration the one or more locking tabs may be configured to be engageable with corresponding one or more slots formed in a fold line formed along an intersection of the second side panel and the fourth floor panel. The closure portion may include a first closure side panel extending from a first side top edge of the top opening of the container portion; a second closure side panel extending from a second opposing side top edge of the top opening of the container portion; a first closure end panel extending from a first end top edge of the top opening of the container portion; and a second closure end panel extending from a second opposing end top edge of the top opening of the container portion. The first closure side panel may include a first handle portion and the second closure side panel may include a second handle portion. The at least one of the first handle portion or the second handle portion may include a handle locking flap, wherein the handle locking flap maybe configurable to lock the first handle portion and the second handle portion together in a closed state. The first closure end panel and the second closure end panel may each be configured such that in an assembled and closed state the first closure end panel and the second closure end panel are of a generally triangular shape and are further configured to be folded downward such that an end portion of the first closure end panel may be engageable with a first receiving slot disposed in the first end panel of the container portion and an end portion of the second closure end panel may be engageable with a second receiving slot disposed in the second end panel of the container portion. The vented carton may further include at least one divider portion, wherein the at least one divider portion is disposed in the container portion. The at least one divider portion may include a divider floor portion; a divider panel; and a divider fold line formed at an intersection of the divider floor portion and the divider panel, wherein the divider fold line may be configured to allow the divider panel to be foldable to a generally perpendicular position relative to the divider floor portion. The divider panel may include at least one locking tab formed on at least one side edge of the divider panel, and wherein the at least one locking tab may be configured to engage with at least one side portion of the container portion to lock the divider panel in a substantially vertical position. The vent openings may include slots. The vented carton may include a single piece of material comprising a plurality of fold lines, and wherein the plurality of fold lines are configured to allow the vented carton to be transformed from a flat pre-folded first configuration to an assembled folded second configuration. The one or more of the first closure side panel, the second closure side panel, the first closure end panel, and the second closure end panel may be removable. The closure portion may include a top lid panel extending from a fold line formed along an intersection of the top lid panel and a side top edge of the top opening of the container portion; a tuck flap extending from a fold line formed along an intersection of the tuck flap and an edge of the top lid panel opposite that of where the top lid panel intersects with the side top edge of the top opening of the container portion; a first end panel flap extending from a fold line formed along an intersection of the first end panel flap and a first end top edge of the top opening of the container portion; and a second end panel flap extending from a fold line formed along an intersection of the second end panel flap and a second end top edge of the top opening of the container portion. The one or more of the top lid panel, the first end panel flap, and the second end panel flap may be removable.

In another embodiment, a method of assembling a vented carton is provided. The method may include providing a single piece of material including a plurality of fold lines and vent openings, wherein the plurality of fold lines are configured to allow the vented carton to be transformed from a flat pre-folded first configuration to an assembled folded second configuration; folding along the plurality of fold lines to transform the vented carton from the flat pre-folded first configuration to the assembled folded second configuration. The vented carton in the assembled folded second configuration, may include a container portion; a closure portion, wherein the closure portion is configured to secure a top opening of the container portion; and an arrangement of vent openings, wherein the arrangement of vent opening may be formed in either or both of the container portion and the closure portion; and securing the vented carton in the assembled folded second configuration.

In another embodiment, a method of using a vented carton is provided. The method may include providing an assembled vented carton, wherein the vented carton may include a container portion; a closure portion, wherein the closure portion is configured to secure a top opening of the container portion; and an arrangement of vent openings, wherein the arrangement of vent opening are formed in either or both of the container portion and the closure portion. The method may further include placing contents into the container portion; and closing the top opening of the container portion using the closure portion. Closing the top opening of the container portion using the closure portion, may include bringing a first handle portion and a second handle portion of the closure portion together and securing; engaging a first folded closure end panel of the closure portion into a first receiving slot of a first end panel of the container portion and engaging a second folded closure end panel of the closure portion into a second receiving slot of second end panel of the container portion. Closing the top opening of the container portion using the closure portion, may include folding down a top lid panel of the closure portion such that it covers the top opening of the container portion; and tucking a tuck flap such that a surface of the tuck flap is positioned against a portion of an inner surface of a front side panel of the container portion, wherein the tuck flap is foldable and extends from a fold line formed along an intersection of the tuck flap and a front edge of the top lid panel.

### BRIEF DESCRIPTION OF THE DRAWINGS

Having thus described the subject matter in general terms, reference will now be made to the accompanying drawings, which are not necessarily drawn to scale, and wherein:

FIG. 1 through FIG. 8 illustrate various views of an example of a carton including multiple compartments, ventilation, and carry handles, in accordance with an embodiment of the invention;

FIG. 9 illustrates a plan view of the carton shown in FIG. 1 through FIG. 8 in a flat pre-folded configuration, in accordance with an embodiment of the invention;

FIG. 10 illustrates the plan view of the carton shown in FIG. 9 including example dimensions, in accordance with an embodiment of the invention;

FIG. 11 illustrates a flow diagram of an example of a method of using the carton shown in FIG. 1 through FIG. 10 and including the multiple compartments, ventilation, and carry handles, in accordance with an embodiment of the invention;

FIG. 12 through FIG. 19 illustrate various views of an example of a carton including multiple compartments, ventilation, and flat closable lid, in accordance with an embodiment of the invention;

FIG. 20 illustrates a plan view of the carton shown in FIG. 12 through FIG. 19 in a flat pre-folded configuration, in accordance with an embodiment of the invention;

FIG. 21 illustrates the plan view of the carton shown in FIG. 20 including example dimensions, in accordance with an embodiment of the invention; and

FIG. 22 illustrates a flow diagram of an example of a method of using the carton shown in FIG. 12 through FIG. 21 and including the multiple compartments, ventilation, and flat closable lid, in accordance with an embodiment of the invention.

### DETAILED DESCRIPTION

The subject matter of the invention now will be described more fully hereinafter with reference to the accompanying drawings, in which some, but not all embodiments of the subject matter of the invention are shown. Like numbers refer to like elements throughout. The subject matter of the invention may be embodied in many different forms and should not be construed as limited to the embodiments set forth herein; rather, these embodiments are provided so that this disclosure will satisfy applicable legal requirements. Indeed, many modifications and other embodiments of the subject matter of the invention set forth herein will come to mind to one skilled in the art to which the subject matter pertains having the benefit of the teachings presented in the foregoing descriptions and the associated drawings. Therefore, it is to be understood that the subject matter of the invention is not to be limited to the specific embodiments disclosed and that modifications and other embodiments are intended to be included within the scope of the appended claims.

In some embodiments, the subject matter of the invention provides cartons, such as food cartons, and methods including multiple compartments, such as for food, and ventilation.

In some embodiments, the carton provides a container portion for holding any desired contents (e.g., food items), a closure portion for securing the top opening of the container portion and for providing carry handles, and a divider portion for providing multiple compartments (e.g., two compartments) within the container portion.

In some embodiments, the carton provides a container portion for holding any desired contents (e.g., food items), a flat closable lid for securing the top opening of the container portion, and a divider portion for providing multiple compartments (e.g., two compartments) within the container portion.

In some embodiments, the carton provides a container portion and a closure portion including one or more arrangements of vent slots (or openings) for preventing the buildup of excessive moisture inside the carton and thereby helping to keep the contents, e.g., food, crisp and not soggy.

Further, methods of using the cartons including the multiple compartments and ventilation are provided.

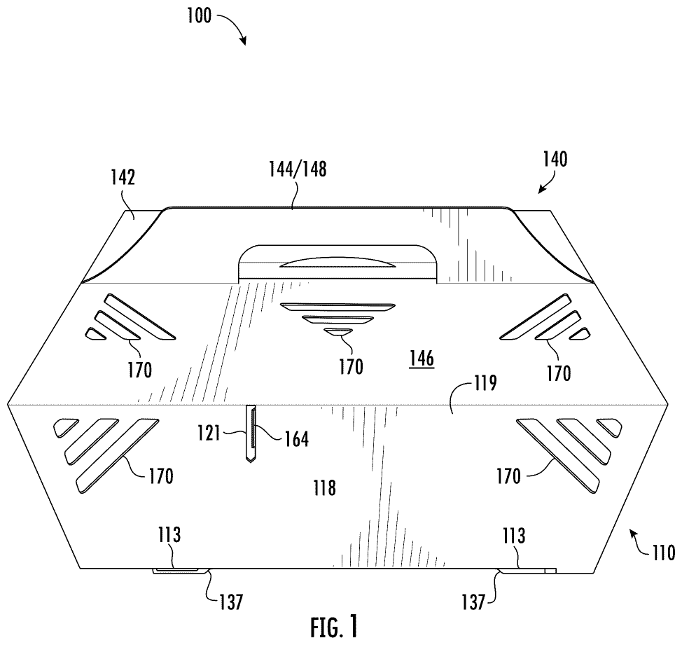

Referring now to FIG. 1 through FIG. 8 illustrate various views of an example of a carton 100 including multiple food compartments, ventilation, and carry handles, in accordance with an embodiment of the invention.

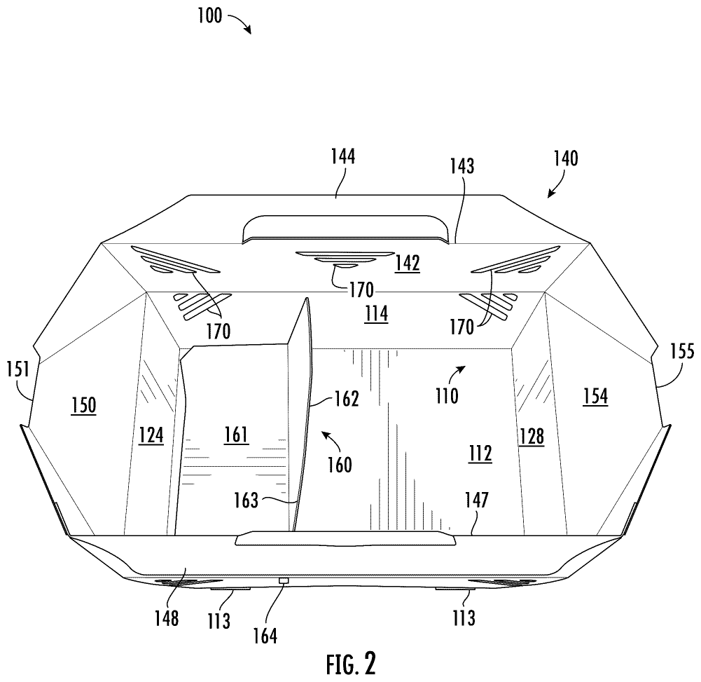

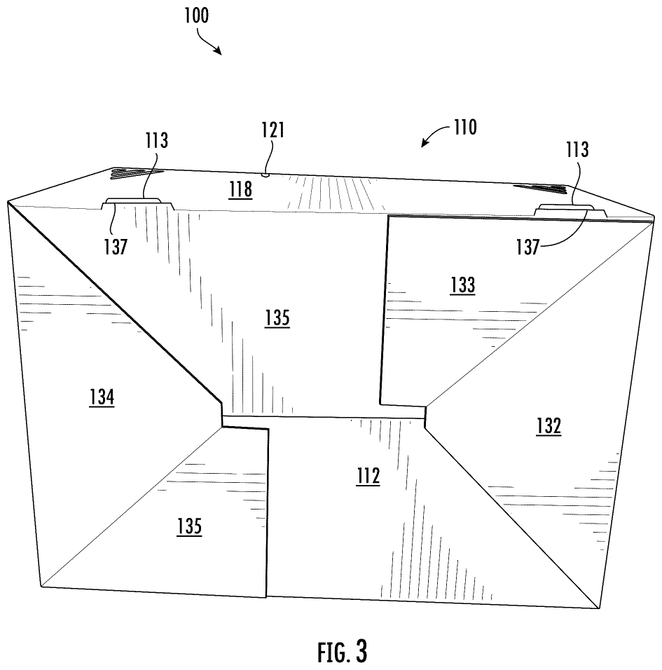

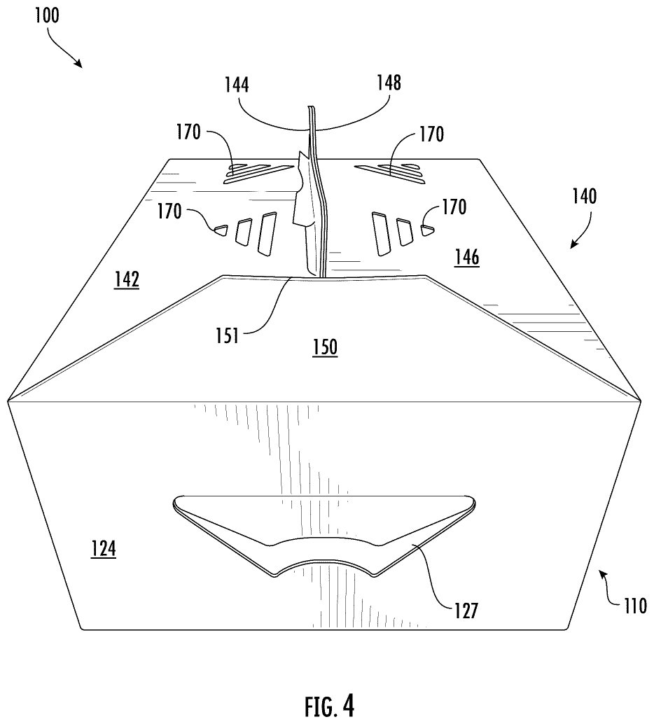

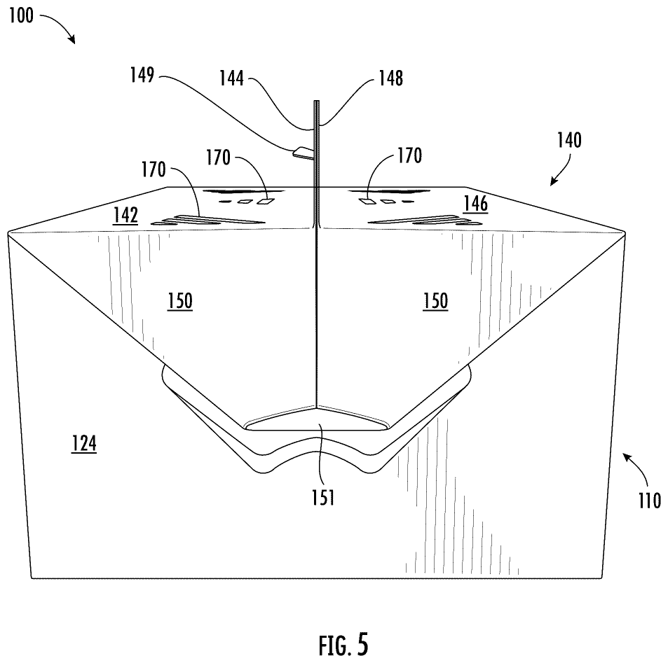

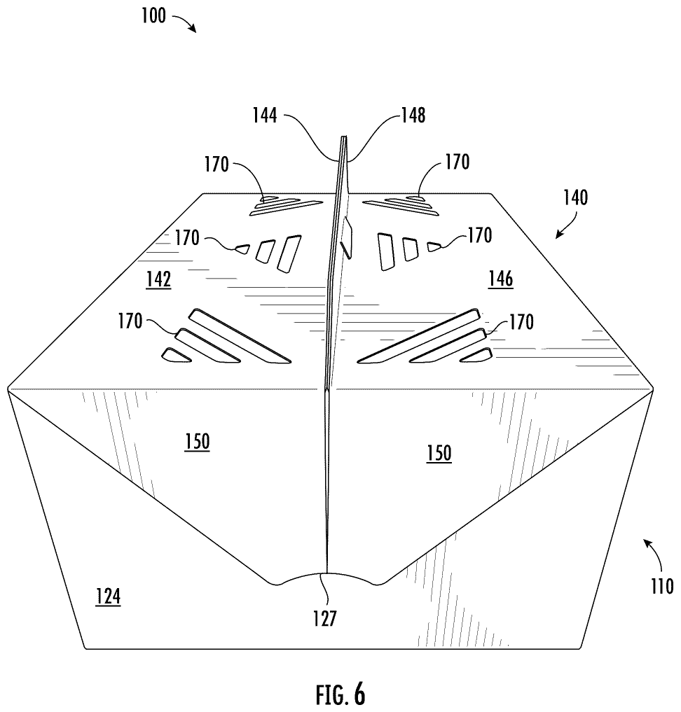

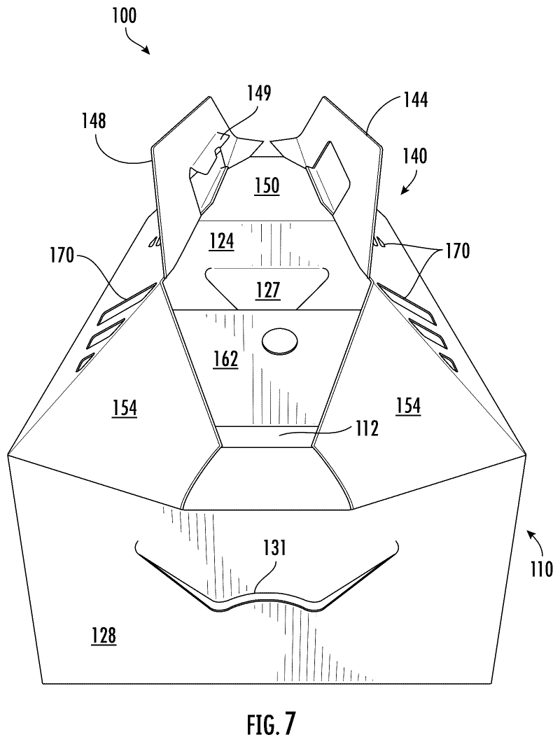

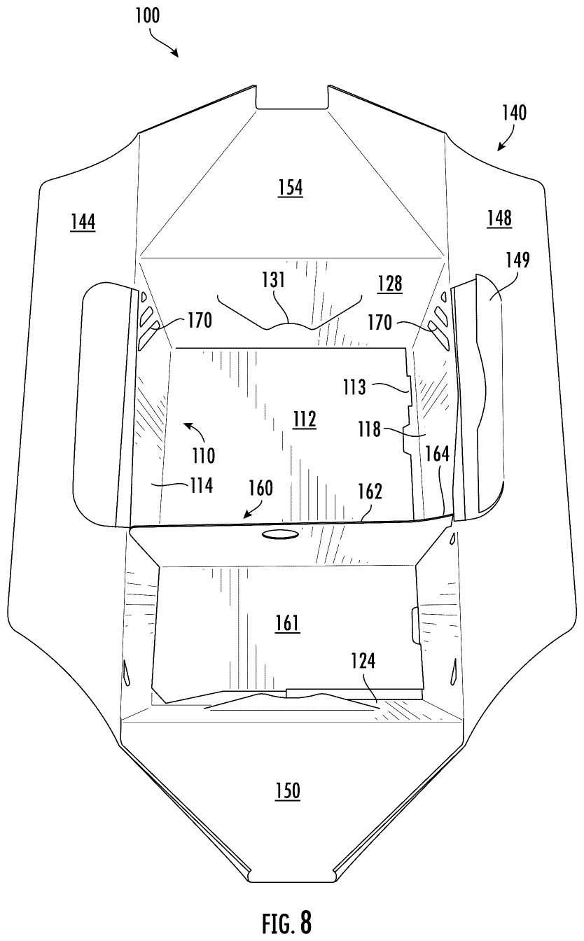

For example, FIG. 1 shows a perspective view of carton 100 in a closed state. FIG. 2 shows a perspective view of carton 100 in an open state. FIG. 3 shows a bottom view of carton 100. FIG. 4 shows a perspective end view of carton 100 and showing an example of a receiving tab or slot. FIG. 5 shows another perspective end view of carton 100 and showing an example of a folded end panel. FIG. 6 shows yet another perspective end view of carton 100 and showing an example of the folded end panel engaged with the receiving tab or slot. FIG. 7 shows a perspective view of carton 100 in a partially open state. Further, FIG. 8 shows a perspective top view of carton 100 in a substantially open state.

Referring still to FIG. 1 through FIG. 8, carton 100 may include a container portion 110 for holding any desired contents (e.g., food items), a closure portion 140 for securing the top opening of container portion 110 and for providing carry handles, and a divider portion 160 for providing one or more compartments, e.g., for food, (e.g., two compartments) within container portion 110.

Additionally, multiple arrangements of vent slots (or openings) 170 may be provided in the various panels forming carton 100. The arrangements of vent slots (or openings) 170 are hereafter called vent arrangements 170. The vent arrangements 170 provide ventilation in carton 100. A benefit of vent arrangements 170 of carton 100 may be that, when holding, for example, hot food, they allow some amount of moisture to escape carton 100. Thereby preventing excessive moisture from building up inside carton 100. Thereby helping to keep the food contents of carton 100 crisp and not soggy. In an alternate embodiment carton 100 may not include any vent slots (or openings) 170.

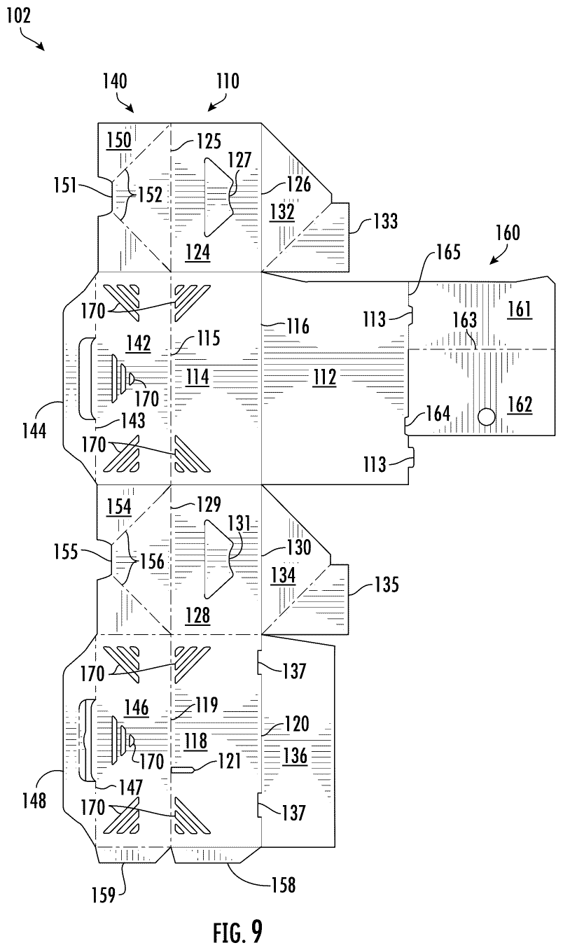

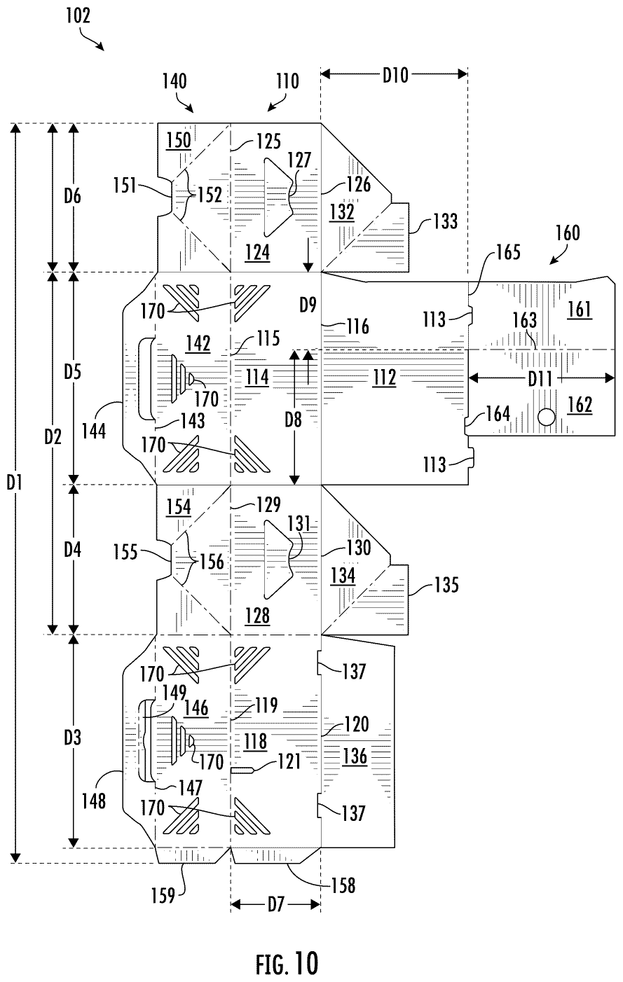

Further, FIG. 9 and FIG. 10 show plan views of the food carton shown in FIG. 1 through FIG. 8 in a flat pre-folded configuration 102, in accordance with an embodiment of the invention. With respect to forming, for example, paperboard products, this flat pre-folded configuration is also called a “blank.” FIG. 9 and FIG. 10 show plan views of carton 100.

Referring now to FIG. 1 through FIG. 10, with respect to carton 100 being, for example, a disposable food container, carton 100 may be formed of any lightweight, rigid or semi-rigid material that is suitable for holding and/or transporting, for example, a quantity of cold and/or hot food and that is also suitable for disposing of after use. For example, carton 100 can be formed of corrugated cardboard, micro-fluted corrugated material, paper, solid unbleached sulphate (SUS) paperboard, solid bleached sulphate (SBS) paperboard, post-consumer paperboard (i.e., recycled materials), biodegradable materials (e.g., sugarcane and paper), polystyrene foam (e.g., Styrofoam), plastic, molded fiber, and/or the like.

In one example, carton 100 may include a fast top style. In one example, carton 100 may be formed of 0.020-thick SUS paperboard with a horizontal grain. Carton 100 may be, in one non-limiting example, about 11 5/16 inches long, about 8 inches wide, and about 5½ inches high. Referring to FIG. 9 and FIG. 10, carton 100 in the flat pre-folded configuration 102 may be about 39 15/32 inches by about 26 7/32 inches. It is understood that other dimensions are contemplated by the disclosure of the invention.

Referring to FIG. 10, carton 100 in the flat pre-folded configuration 102 may, in one non-limiting example, have the following example dimensions:
D1 about 39 15/32 inches;
D2 about 19 5/16 inches;
D3 about 11 5/16 inches;
D4 about 8 inches;
D5 about 11 5/16 inches;
D6 about 7.966 inches;
D7 about 4¾ inches;
D8 about 7¼ inches;
D9 about 4 1/16 inches;
D10 about 7.862 inches; and
D11 about 7⅞ inches.

It is understood that other dimensions are contemplated by the disclosure of the invention, and the above are examples only.

Further, using the various glue tabs and/or the like, carton 100 may be held in its folded assembled configuration by glue or other adhesive coating (e.g., a heat/thermal activated coating), and/or tabs.

Referring still to FIG. 1 through FIG. 10, container portion 110 of carton 100 may include, for example, a first floor panel 112 with two locking tabs 113; a first side panel 114 having a top fold line 115 and a bottom fold line 116; a second side panel 118 having a top fold line 119, a bottom fold line 120, a side slot 121, and a glue tab 158; a first end panel 124 having a top fold line 125, a bottom fold line 126, and a receiving tab or slot 127; a second end panel 128 having a top fold line 129, a bottom fold line 130, and a receiving tab or slot 131; a second floor panel 132 with a glue tab 133; a third floor panel 134 with a glue tab 135; a fourth floor panel 136; and two receiving slots 137 along bottom fold line 120 of second side panel 118 for receiving the two locking tabs 113.

Referring still to FIG. 1 through FIG. 10, closure portion 140 of carton 100 may include, for example, a first side panel 142 having a top fold line 143 and a handle 144; a second side panel 146 having a top fold line 147, a handle 148, handle locking flap 149, and a glue tab 159; a first end panel 150 having a notch 151 and two fold lines 152; a second end panel 154 having a notch 155 and two fold lines 156.

Referring still to FIG. 1 through FIG. 10, divider portion 160 of carton 100 may include, for example, a floor panel 161, a divider panel 162, fold line 163 between floor panel 161 and divider panel 162, and a locking tab 164 on divider panel 162.

Further, and referring now again to flat pre-folded configuration 102 shown in FIG. 9 and FIG. 10, a fold line 165 may be provided between floor panel 161 of divider portion 160 and first floor panel 112 of container portion 110 of carton 100. In this way, divider portion 160 may be folded and positioned when carton 100 is in use, as shown, for example, in FIG. 2, FIG. 7, and FIG. 8. In this example, divider portion 160 may be provided with a 90-degree fold at fold line 163. Then, floor panel 161 of divider portion 160 may be arranged on first floor panel 112 of container portion 110 of carton 100. Then, locking tab 164 of divider panel 162 of divider portion 160 may be engaged with side slot 121 of second side panel 118 of container portion 110 of carton 100. In this example, divider portion 160 may be designed such that one compartment may be larger than the other compartment of container portion 110 of carton 100.

In this way, divider portion 160 may be used to provide two compartments within carton 100. However, the design of divider portion 160 is not limited to that shown FIG. 1 through FIG. 10. This is exemplary only. Divider portion 160 and container portion 110 of carton 100 may be designed and sized to provide more than two compartments within carton 100. For example, divider portion 160 and container portion 110 of carton 100 may be designed to provide three, four, or five compartments within carton 100 and wherein carton 100 may be sized accordingly. Further, in other embodiments, carton 100 may omit or not deploy divider portion 160 all together and thereby provide a one compartment carton 100.

Referring still to FIG. 1 through FIG. 10, vent arrangements 170 may be provided, for example, in first side panel 114 and second side panel 118 of container portion 110 of carton 100. Vent arrangements 170 may also be provided in first side panel 142 and second side panel 146 of closure portion 140 of carton 100. The placement, shape, and/or number of vent arrangements 170 in carton 100 is not limited to that shown in FIG. 1 through FIG. 10. This is exemplary only. Other vent arrangements 170 in carton 100 of varying placement, shape, and/or number are possible, and contemplated herein.

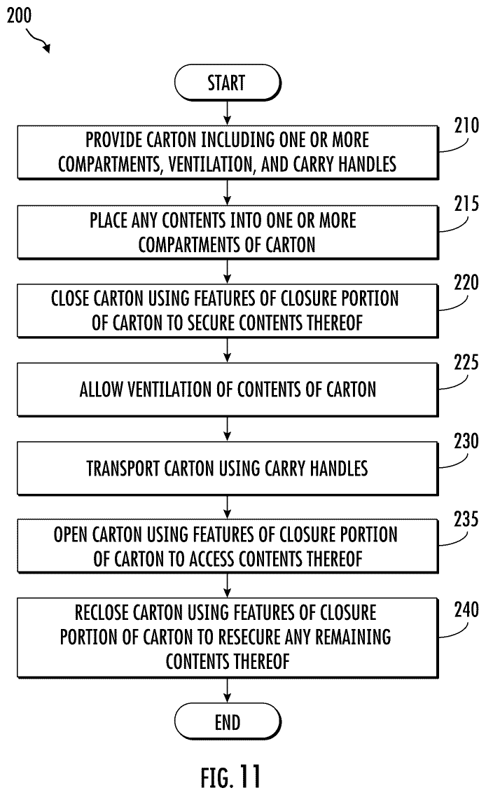

Referring now to FIG. 11 illustrates a flow diagram of an example of a method 200 of using the carton shown in FIG. 1 through FIG. 10 and including the multiple compartments, ventilation, and carry handles, in accordance with an embodiment of the invention. Method 200 may include, but is not limited to, the following steps.

At a step 210, a carton, such as for food, is provided that includes one or more compartments, e.g., for food, ventilation, and carry handles. For example, carton 100 may be provided that includes container portion 110 for holding any desired contents (e.g., food items), closure portion 140 for securing the top opening of container portion 110 and for providing handles 144 and 148, and divider portion 160 for providing two compartments within container portion 110. Further, the panels forming carton 100 may include any number, shape, arrangement, and/or locations of vent arrangements 170. Optionally, if carton 100 is initially provided in a flat pre-folded configuration 102, it may be folded from its flat pre-folded configuration 102 to its folded assembled state.

At a step 215, any contents, e.g., food, may be placed into the one or more compartments of the carton. For example, any cold or hot food items may be placed into container portion 110 of carton 100. In a specific non-limiting example, heated fried chicken may be placed in the larger compartment of container portion 110 of carton 100 and dipping sauces may be placed in the smaller compartment of container portion 110.

At a step 220, the carton is closed using the features of the closure portion of the carton to secure the contents thereof. For example, carton 100 may be closed using the features of closure portion 140 to secure the contents thereof. Namely, by bringing handles 144 and 148 of closure portion 140 together and folding handle locking flap 149 over to engage handles 144 and 148 with one another, and by engaging the folded first end panel 150 of closure portion 140 into receiving tab or slot 127 of first end panel 124 of container portion 110, as shown for example in FIG. 6. Also, by engaging the folded second end panel 154 of closure portion 140 into receiving tab or slot 131 of second end panel 128 of container portion 110.

At a step 225, the ventilation of the contents of the carton is allowed. For example, the presence of vent arrangements 170 in carton 100 allows ventilation of, for example, food contents of carton 100. Using the example of heated fried chicken within container portion 110 of carton 100, ventilation is allowed of the heated fried chicken via vent arrangements 170. In this way, it may help the heated fried chicken to remain crispy and not soggy within carton 100 for some period of time.

At a step 230, the carton may be transported using carry handles. For example, carton 100 may be transported (i.e., picked up and carried) using handles 144 and 148 of closure portion 140.

At a step 235, the carton may be opened using the features of the closure portion of the carton to access the contents thereof. For example, carton 100 may be opened using the features of closure portion 140 to access the contents thereof. Namely, by disengaging the folded first end panel 150 of closure portion 140 from receiving tab or slot 127 of first end panel 124 of container portion 110, as shown for example in FIG. 5. Also, by disengaging the folded second end panel 154 of closure portion 140 from receiving tab or slot 131 of second end panel 128 of container portion 110.

At a step 240, the carton may be reclosed using the features of the closure portion of the carton to re-secure the contents thereof. For example, carton 100 may be reclosed using the features of closure portion 140 to re-secure the contents thereof. Namely, by reengaging the folded first end panel 150 of closure portion 140 into receiving tab or slot 127 of first end panel 124 of container portion 110, as shown for example in FIG. 6. Also, by reengaging the folded second end panel 154 of closure portion 140 into receiving tab or slot 131 of second end panel 128 of container portion 110.

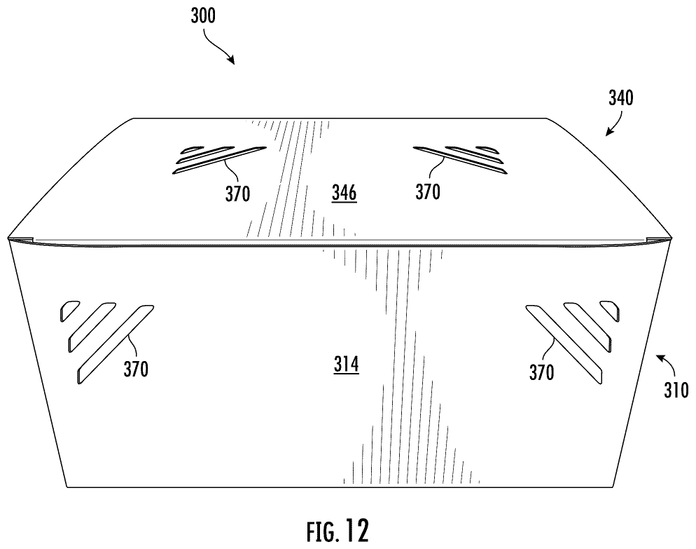

Referring still to FIG. 1 through FIG. 11, carton 100 may be considered a fast top style of container because of the presence of handles 144 and 148, which are provided for convenient carry handles. However, carton 100 is not limited to the fast top style of container with carry handles (e.g., handles 144 and 148). In other embodiments, the carton of the invention may be absent the carry handles and instead provide a tuck top style of container. An example of which is shown below in FIG. 12 through FIG. 22.

Referring now to FIG. 12 through FIG. 19 illustrate various views of an example of a carton 300 including multiple food compartments, ventilation, and a flat closable lid, in accordance with an embodiment of the invention.

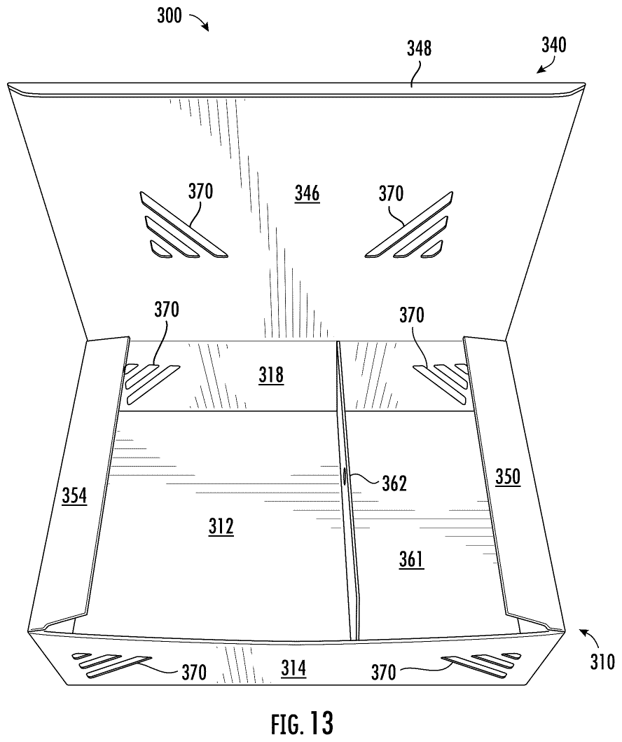

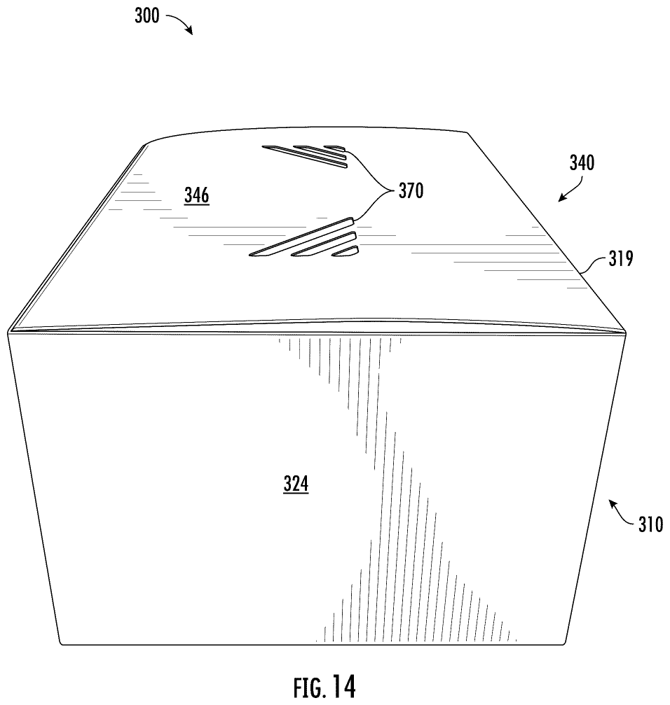

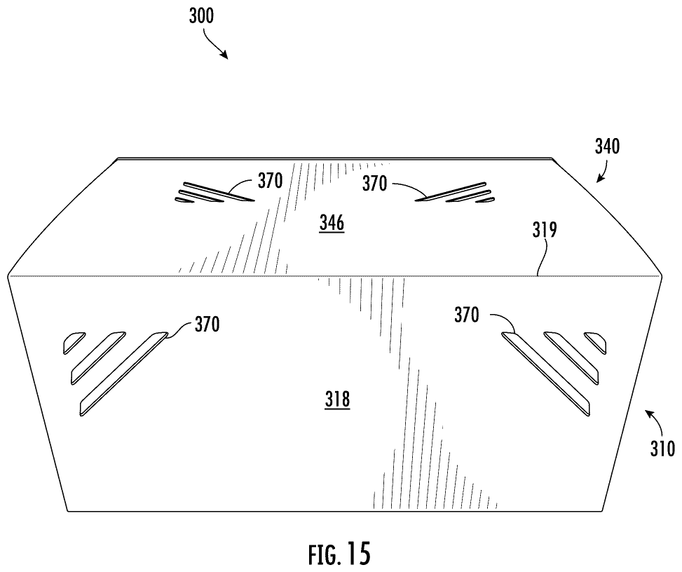

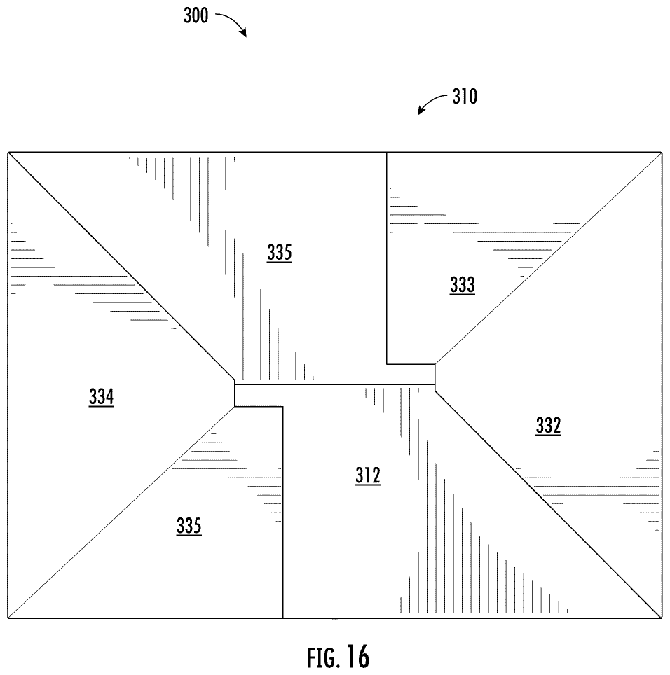

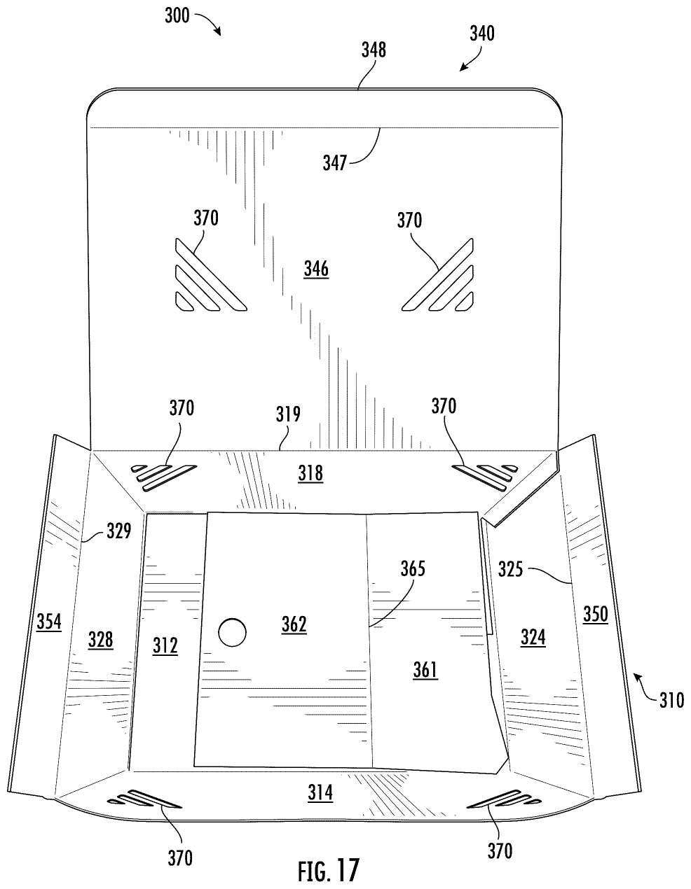

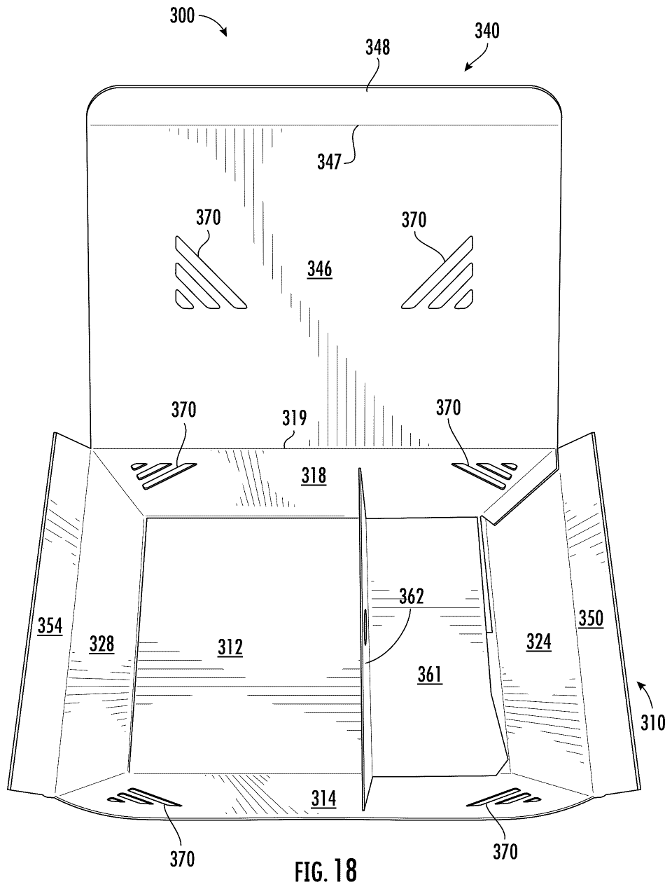

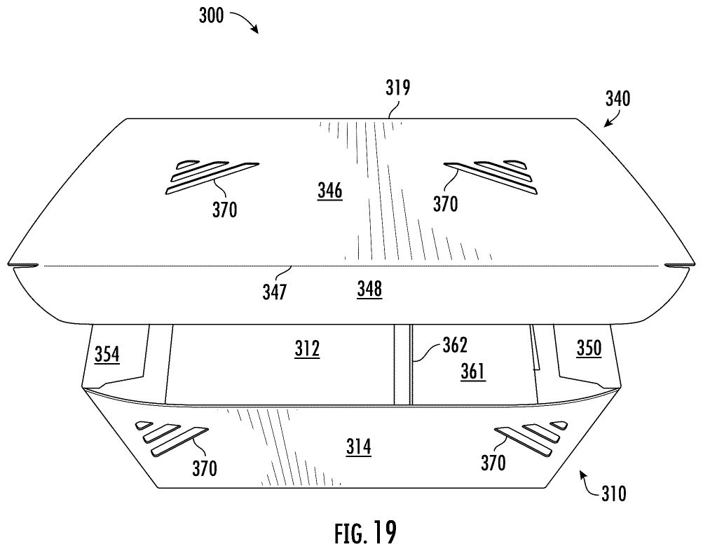

For example, FIG. 12 shows a perspective view of carton 300 in a closed state. FIG. 13 shows a perspective view of carton 300 in an open state. FIG. 14 shows a perspective end view of carton 300. FIG. 15 shows a perspective back view of carton 300. FIG. 16 shows a bottom view of carton 300. FIG. 17 shows a perspective top view of carton 300 in an open state and with the divider in a flattened state. FIG. 18 shows a perspective top view of carton 300 in an open state and with the divider folded up. Further, FIG. 19 shows a perspective top view of carton 300 in a partially open state.

Referring still to FIG. 12 through FIG. 19, carton 300 may include a container portion 310 for holding any desired contents (e.g., food items), a closure portion 340 for securing the top opening of container portion 310 and for providing a flat closable lid, and a divider portion 360 for providing one or more compartments, e.g., for food, (e.g., two compartments) within container portion 310.

Additionally, multiple arrangements of vent slots (or openings) 370 may be provided in the various panels forming carton 300. The arrangements of vent slots (or openings) 370 are hereafter called vent arrangements 370. The vent arrangements 370 provide ventilation in carton 300. A benefit of vent arrangements 370 of carton 300 may be that, when holding hot food, for example, they allow some amount of moisture to escape carton 300. Thereby preventing excessive moisture from building up inside carton 300. Thereby helping to keep, for example, food contents of carton 300 crisp and not soggy. In an alternate embodiment carton 300 may not include any vent slots (or openings) 370.

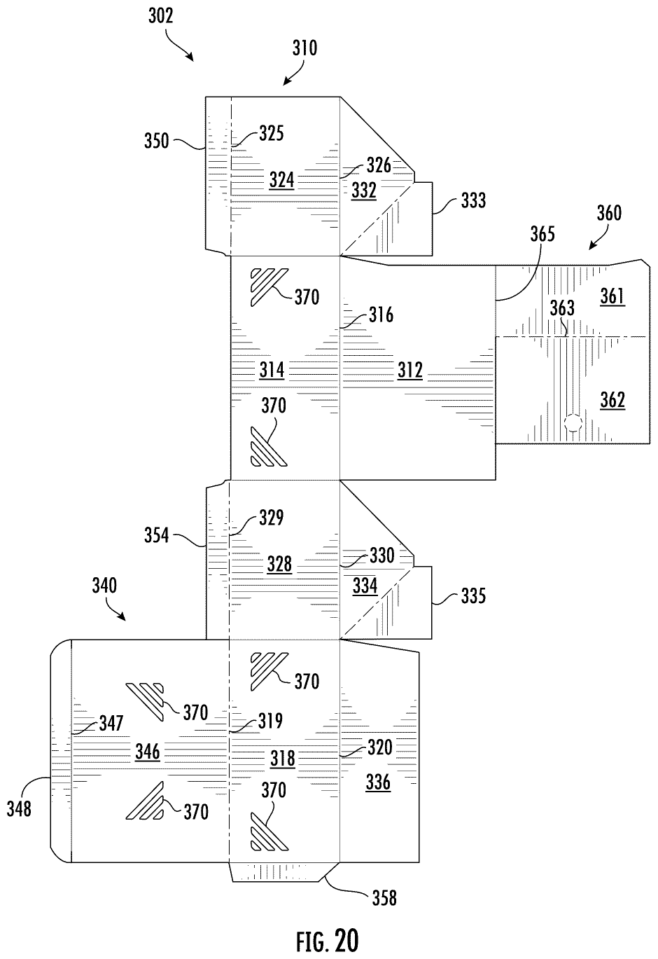

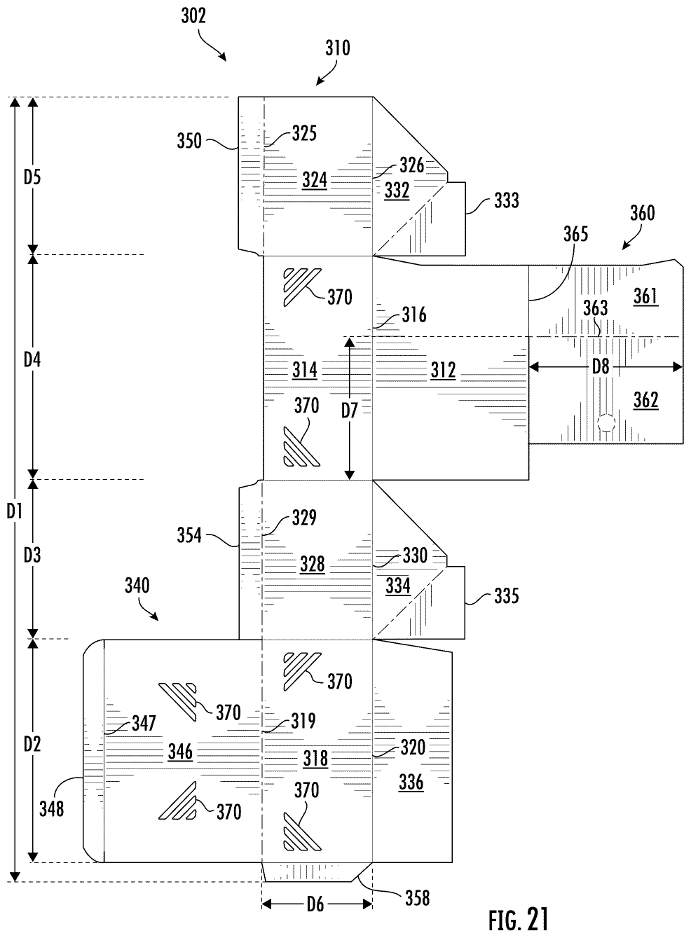

Further, FIG. 20 and FIG. 21 illustrate plan views of the carton shown in FIG. 12 through FIG. 19 in a flat pre-folded configuration 302, in accordance with an embodiment of the invention. With respect to forming, for example, paperboard products, this flat pre-folded configuration is also called a “blank.” FIG. 20 and FIG. 21 show outside plan views of carton 300.

Referring now to FIG. 12 through FIG. 21, with respect to carton 300 being, for example, a disposable food container, carton 300 may be formed of any lightweight, rigid or semi-rigid material that is suitable for holding and/or transporting, for example, a quantity of cold and/or hot food and that is also suitable for disposing of after use. For example, carton 300 can be formed of corrugated cardboard, micro-fluted corrugated material, paper, SUS paperboard, SBS paperboard, post-consumer paperboard (i.e., recycled materials), biodegradable materials (e.g., sugarcane and paper), polystyrene foam (e.g., Styrofoam), plastic, molded fiber, and the like.

In one example, carton 300 may include a tuck top style. In one example, carton 300 may be formed of 0.018-thick SBS paperboard with a horizontal grain. Carton 300 may be, for example, about 11 5/16 inches long, about 8 inches wide, and about 5½ inches high. Referring to FIG. 20 and FIG. 21, carton 300 may include five folded layers.

Referring to FIG. 21, carton 300 in the flat pre-folded configuration 302 may, in one non-limiting example, have the following example dimensions:
D1 about 39 15/32 inches;
D2 about 11 5/16 inches;
D3 about 8 inches;
D4 about 11 5/16 inches;
D5 about 7.966 inches;
D6 about 5½ inches;
D7 about 7¼ inches; and
D8 about 7¾ inches.

It is understood that other dimensions are contemplated by the disclosure of the invention, and the above are examples only.

Further, using the various glue tabs and/or the like, carton 300 may be held in its folded assembled configuration by glue or other adhesive coating (e.g., a heat/thermal activated coating), and/or tabs.

Referring still to FIG. 12 through FIG. 21, container portion 310 of carton 300 may include, for example, a first floor panel 312; a first side panel 314 having a bottom fold line 316; a second side panel 318 having a top fold line 319, a bottom fold line 320, and a glue tab 358; a first end panel 324 having a top fold line 325 and a bottom fold line 326; a second end panel 328 having a top fold line 329 and a bottom fold line 330; a second floor panel 332 with a glue tab 333; a third floor panel 334 with a glue tab 335; and a fourth floor panel 336.

Referring still to FIG. 12 through FIG. 21, closure portion 340 of carton 300 may include, for example, a top lid panel 346 having a top fold line 347 and a flap 348; a first end panel 350; and a second end panel 354.

Referring still to FIG. 12 through FIG. 21, divider portion 360 of carton 300 may include, for example, a floor panel 361, a divider panel 362, and a fold line 363 between floor panel 361 and divider panel 362.

Further, and referring now again to flat pre-folded configuration 302 shown in FIG. 9 and FIG. 10, a fold line 365 may be provided between floor panel 361 of divider portion 360 and first floor panel 312 of container portion 310 of carton 300. In this way, divider portion 360 may be arranged in container portion 310 of carton 300. Then, divider portion 360 may be positioned within container portion 310 when carton 300 is in use, as shown, for example, in FIG. 13, FIG. 18, and FIG. 19. In this example, divider portion 360 may be provided with a 90-degree fold at fold line 363. Then, floor panel 361 of divider portion 360 may be arranged on first floor panel 312 of container portion 310 of carton 300. In this example, divider portion 360 may be designed such that one compartment may be larger than the other compartment of container portion 310 of carton 300.

In this way, divider portion 360 may be used to provide two compartments within carton 300. However, the design of divider portion 360 is not limited to that shown FIG. 12 through FIG. 21. This is exemplary only. Divider portion 360 and container portion 310 of carton 300 may be designed and sized to provide more than two compartments within carton 300. For example, divider portion 360 and container portion 310 of carton 300 may be designed to provide three, four, or five compartments within carton 300 and wherein carton 300 may be sized accordingly. Further, in other embodiments, carton 300 may omit divider portion 360 all together and thereby provide a one compartment carton 300.

Referring still to FIG. 12 through FIG. 21, vent arrangements 370 may be provided, for example, in first side panel 314 and/or second side panel 318 of container portion 310 of carton 300. Vent arrangements 370 may also (or alternatively) be provided in flat closable lid of closure portion 340 of carton 300. Vent arrangements 370 may also (or alternatively) be provided in first end panel 324 and/or second end panel 328. The placement, shape, and/or number of vent arrangements 370 in carton 300 is not limited to that shown FIG. 12 through FIG. 21. This is exemplary only. Other vent arrangements 370 in carton 300 of varying placement, shape, and/or number are possible, and contemplated herein.

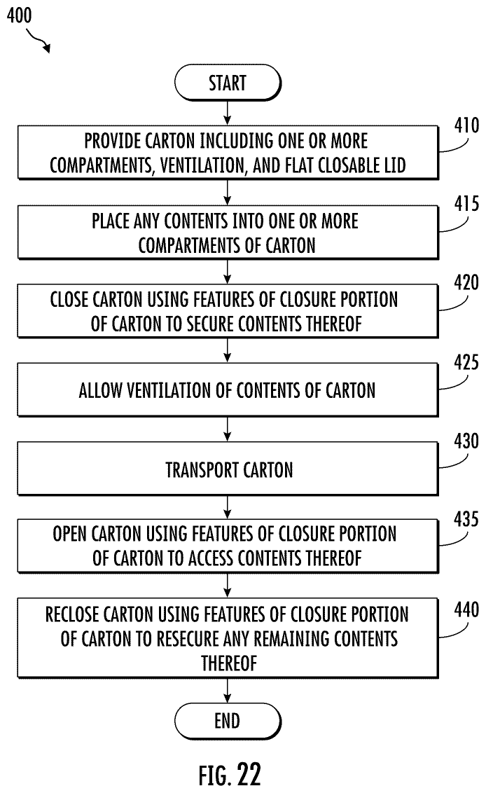

Referring now to FIG. 22 illustrates a flow diagram of an example of a method 400 of using the carton shown in FIG. 12 through FIG. 21 and including the multiple compartments, ventilation, and flat closable lid, in accordance with an embodiment of the invention. Method 400 may include, but is not limited to, the following steps.

At a step 410, a carton (e.g., food carton) is provided that includes one or more compartments (e.g., food compartments), ventilation, and flat closable lid. For example, carton 300 may be provided that includes container portion 310 for holding any desired contents (e.g., food items), closure portion 340 for securing the top opening of container portion 310 via flat closable lid 346 with its flap 348, and divider portion 360 for providing compartments within container portion 310. Further, the panels forming carton 300 may include any number, shape, arrangement, and/or locations of vent arrangements 370. Optionally, if carton 300 is initially provided in a flat pre-folded configuration 302, it may be folded from its flat pre-folded configuration 302 to its folded assembled state.

At a step 415, any contents, e.g., food, may be placed into the one or more compartments of the carton. For example, any cold or hot food items may be placed into container portion 310 of carton 300. In a specific example, heated fried chicken may be placed in the larger compartment of container portion 310 of carton 300 and dipping sauces may be placed in the smaller compartment of container portion 310.

At a step 420, the carton may be closed using the features of the closure portion of the carton to secure the contents thereof. For example, carton 300 may be closed using the features of closure portion 340 to secure the contents thereof. Namely, by folding shut flat closable lid 346 with its flap 348 against container portion 310.

At a step 425, the ventilation of the contents of the carton is allowed. For example, the presence of vent arrangements 370 in carton 300 allows ventilation of the contents, e.g., food, of carton 300. Using the example of heated fried chicken within container portion 310 of carton 300, ventilation is allowed of the heated fried chicken via vent arrangements 370. In this way, it may help the heated fried chicken to remain crispy and not soggy within carton 300 for some period of time.

At a step 430, the carton may be transported. For example, carton 300 may be picked up and carried.

At a step 435, the carton may be opened using the features of the closure portion of the carton to access the contents thereof. For example, carton 300 may be opened using the features of closure portion 340 to access the contents thereof. Namely, by opening up flat closable lid 346 with its flap 348 from container portion 310.

At a step 440, the carton may be reclosed using the features of the closure portion of the carton to re-secure the contents thereof. For example, carton 300 may be reclosed using the features of closure portion 340 to re-secure the contents thereof. Namely, by folding shut flat closable lid 346 with its flap 348 against container portion 310.

In summary and referring now again to FIG. 1 through FIG. 22, cartons 100, 300 and methods 200, 400 may provide container portions 110, 310, respectively, for holding any desired contents (e.g., food items), closure portions 140, 340, respectively, for securing the top opening of container portions 110, 310, respectively, and divider portions 160, 360, respectively, for providing one or more compartments (e.g., two compartments) within the container portions 110, 310, respectively. Further, carton 100 and method 200 provide carry handles 144, 148. Further, carton 300 and method 400 provide flat closable lid (e.g., top lid panel 346 with its flap 348).

In some embodiments, cartons 100, 300 and methods 200, 400 may provide container portions 110, 310, respectively, and closure portions 140, 340, respectively, including one or more arrangements of vent slots (e.g., vent arrangements 370) for preventing the buildup of excessive moisture inside cartons 100, 300 and thereby helping to keep, for example, the food contents crisp and not soggy.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

The terms “comprise,” “comprises,” “comprising,” “include,” “includes,” and “including,” are intended to be non-limiting, such that recitation of items in a list is not to the exclusion of other like items that may be substituted or added to the listed items.

Terms like “preferably,” “commonly,” and “typically” are not utilized herein to limit the scope of the claimed embodiments or to imply that certain features are critical or essential to the structure or function of the claimed embodiments. These terms are intended to highlight alternative or additional features that may or may not be utilized in a particular embodiment of the present invention.

The term “substantially” is utilized herein to represent the inherent degree of uncertainty that may be attributed to any quantitative comparison, value, measurement, or other representation and to represent the degree by which a quantitative representation may vary from a stated reference without resulting in a change in the basic function of the subject matter at issue.

Various modifications and variations of the disclosed methods, compositions and uses of the invention will be apparent to the skilled person without departing from the scope and spirit of the invention. Although the subject matter has been disclosed in connection with specific preferred aspects or embodiments, it should be understood that the subject matter as claimed should not be unduly limited to such specific aspects or embodiments.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A vented carton, comprising:
a. container portion;
b. a closure portion, wherein the closure portion is configured to secure a top opening of the container portion; and
c. an arrangement of vent openings, wherein the arrangement of vent opening are formed in either or both of the container portion and the closure portion.

2. The vented carton of claim 1, wherein the container portion comprises:
a. a floor portion;
b. a first side panel;
c. a second side panel opposite that of the first side panel;
d. a first end panel; and
e. a second end panel opposite that of the first end panel, wherein the floor portion, side panels, and end panels are configurable to form a compartment region of the container portion.

3. The vented carton of claim 2, wherein the floor portion comprises:
a. a first floor panel;
b. a second floor panel;
c. a third floor panel; and
d. a fourth floor panel, wherein the first, second, third, and fourth floor panels are configurable to form the floor portion of the container portion.

4. The vented carton of claim 3, wherein the first floor panel comprise one or more locking tabs extending from a side edge of the first floor panel, and wherein in an assembled configuration the one or more locking tabs are configured to be engageable with corresponding one or more slots formed in a fold line formed along an intersection of the second side panel and the fourth floor panel.

5. The vented carton of claim 1, wherein the closure portion comprises:
a. a first closure side panel extending from a first side top edge of the top opening of the container portion;
b. a second closure side panel extending from a second opposing side top edge of the top opening of the container portion;
c. a first closure end panel extending from a first end top edge of the top opening of the container portion; and
d. a second closure end panel extending from a second opposing end top edge of the top opening of the container portion.

6. The vented carton of claim 5, wherein the first closure side panel comprises a first handle portion and the second closure side panel comprises a second handle portion.

7. The vented carton of claim 6, wherein at least one of the first handle portion or the second handle portion comprises a handle locking flap, wherein the handle locking flap is configurable to lock the first handle portion and the second handle portion together in a closed state.

8. The vented carton of claim 5, wherein the first closure end panel and the second closure end panel are each configured such that in an assembled and closed state the first closure end panel and the second closure end panel comprise a generally triangular shape and are further configured to be folded downward such that an end portion of the first closure end panel is engageable with a first receiving slot disposed in the first end panel of the container portion and an end portion of the second closure end panel is engageable with a second receiving slot disposed in the second end panel of the container portion.

9. The vented carton of claim 1, further comprising at least one divider portion, wherein the at least one divider portion is disposed in the container portion.

10. The vented carton of claim 9, wherein the at least one divider portion comprises:
a. a divider floor portion;
b. a divider panel; and
c. a divider fold line formed at an intersection of the divider floor portion and the divider panel, wherein the divider fold line is configured to allow the divider panel to be foldable to a generally perpendicular position relative to the divider floor portion.

11. The vented carton of claim 10, wherein the divider panel comprises at least one locking tab formed on at least one side edge of the divider panel, and wherein the at least one locking tab is configured to engage with at least one side portion of the container portion to lock the divider panel in a substantially vertical position.

12. The vented carton of claim 1, wherein the vent openings comprise slots.

13. The vented carton of claim 1, wherein the vented carton comprises a single piece of material comprising a plurality of fold lines, and wherein the plurality of fold lines are configured to allow the vented carton to be transformed from a flat pre-folded first configuration to an assembled folded second configuration.

14. The vented carton of claim 5, wherein one or more of the first closure side panel, the second closure side panel, the first closure end panel, and the second closure end panel are removable.

15. The vented carton of claim 1, wherein the closure portion comprises:
a. a top lid panel extending from a fold line formed along an intersection of the top lid panel and a side top edge of the top opening of the container portion;
b. a tuck flap extending from a fold line formed along an intersection of the tuck flap and an edge of the top lid panel opposite that of where the top lid panel intersects with the side top edge of the top opening of the container portion;
c. a first end panel flap extending from a fold line formed along an intersection of the first end panel flap and a first end top edge of the top opening of the container portion; and
d. a second end panel flap extending from a fold line formed along an intersection of the second end panel flap and a second end top edge of the top opening of the container portion.

16. The vented carton of claim 15, wherein one or more of the top lid panel, the first end panel flap, and the second end panel flap are removable.

17. A method of assembling a vented carton, the method comprising:
a. providing a single piece of material comprising a plurality of fold lines and vent openings, wherein the plurality of fold lines are configured to allow the vented carton to be transformed from a flat pre-folded first configuration to an assembled folded second configuration;
b. folding along the plurality of fold lines to transform the vented carton from the flat pre-folded first configuration to the assembled folded second configuration, the vented carton in the assembled folded second configuration, comprising:
i. a container portion;
ii. a closure portion, wherein the closure portion is configured to secure a top opening of the container portion; and
iii. an arrangement of vent openings, wherein the arrangement of vent opening are formed in either or both of the container portion and the closure portion; and
c. securing the vented carton in the assembled folded second configuration.

18. A method of using a vented carton, the method comprising:
a. providing a vented carton, comprising:
i. container portion;
ii. a closure portion, wherein the closure portion is configured to secure a top opening of the container portion; and
iii. an arrangement of vent openings, wherein the arrangement of vent opening are formed in either or both of the container portion and the closure portion;
b. placing contents into the container portion; and
c. closing the top opening of the container portion using the closure portion.

19. The method of claim 18, wherein closing the top opening of the container portion using the closure portion, comprises:
a. bringing a first handle portion and a second handle portion of the closure portion together and securing;
b. engaging a first folded closure end panel of the closure portion into a first receiving slot of a first end panel of the container portion and engaging a second folded closure end panel of the closure portion into a second receiving slot of second end panel of the container portion.

20. The method of claim 18, wherein closing the top opening of the container portion using the closure portion, comprises:
a. folding down a top lid panel of the closure portion such that it covers the top opening of the container portion; and
b. tucking a tuck flap such that a surface of the tuck flap is positioned against a portion of an inner surface of a front side panel of the container portion, wherein the tuck flap is foldable and extends from a fold line formed along an intersection of the tuck flap and a front edge of the top lid panel.
